(19) United States
(12) Patent Application Publication
(10) Pub. No.: US 2026/0299529 A1
(43) Pub. Date: Oct. 1, 2026

(54) Hybrid Model Adaptive Sampling

(71) Applicant: AspenTech Corporation, Bedford, MA (US)

(72) Inventors: Xiaozhou Zou, Woburn, MA (US); Krishnan Kumaran, Raritan, NJ (US)

(21) Appl. No.: 19/096,971

(22) Filed: Apr. 1, 2025

(51) Int. Cl. G05B 13/02

(52) U.S. Cl. CPC G05B 13/027

(57) ABSTRACT

A computer-implemented system and corresponding method for plant process control utilizing adaptive sampling or for plant operation utilizing adaptive sampling. The use of adaptive sampling, by the system and corresponding method, enables the generation of an expansive training dataset using fewer samples from simulations, experiments, or historical plant data. Adaptive sampling fits a surrogate function to a line segment intersecting a select sampled point. The surrogate function is used to compute dense data along the line segment using sparse samples and interpolation from adapted learning. The dense data is used to train a learning machine to control the process of a given plant or to operate the given plant. The supplemental information provided by the dense data increases the efficiency of training the machine learning model as well as improving its accuracy in operating the plant such as in replicating, predicting, and controlling plant process behavior.

### BACKGROUND

Learning, training, and generating complex models such as those used by tools for advanced process control (APC) and other methods for controlling industrial processing systems requires large quantities of high quality training data, significant computational resources, and advanced algorithms such as deep learning. Current state-of-the-art tools use limited data sampling strategies that aim for high, often randomized, coverage of a very large search space. As a result, they do not adequately consider the inherent complexity of the modeled process to sample in an adaptive fashion creating subpar datasets which in turn results in subpar process modeling and control limiting efficiency and productivity.

Models, for example machine learning models, hybrid models, or first principal models, are used to monitor, predict, and control complex plant processes to optimize for desired outcomes (e.g., maximize profit or output) or avoid undesired situations (e.g., minimize inefficiencies or unsafe operations). These models often require datasets comprising of information regarding the monitored plant process that are used as both training datasets and/or model inputs. However, due to the complexity of the monitored plant process these datasets can be very large which necessitates the selection or creation of subsets of data to be used as representative samples of the larger dataset. Traditionally, these subsets were created through sampling techniques such as random sampling, Latin hypercube, and Sobol sequence intended to sample datapoints across the entire dataset space. However, these sampling techniques fail to account for the variability of the modeled plant process’s behavior across the dataset space. For example, under certain conditions the monitored plant process’s behavior may exhibit rapid changes or even strict behavior boundaries. This can require denser sampling to accurately capture these changes. However, denser sampling for conditions under which the monitored plant process’s behavior does not exhibit rapid, if any, changes would unnecessarily bloat the sampled data increasing model computational requirements and generation time.

### SUMMARY

A need exists for adaptive strategies that sample a data space efficiently while also providing high coverage and considering the inherent complexity of the monitored process. According to Applicants, such strategies would, when the process is well-described by a simple model, generate a surrogate function that automatically converges to the right model with low data requirements, while also being able to adapt to the higher data requirements and achieve convergence for complex models.

Applicants address the forgoing shortcomings and need in the art. In particular, Applicants’ approach provides improved model accuracy as well as data efficiency. An adaptive sampling strategy and algorithms to build hybrid models for high-dimensional, complex industrial processes is disclosed herein. The sampling strategy creates surrogate functions representative of a true function describing the variable relationships of a dataset containing data regarding the behavior of complex industrial processes. The surrogate functions can be used, along with the dataset, to create a training dataset for machine learning models. In some embodiments, this sampling strategy consists of two stages. In stage one, a sampling algorithm is used to conduct sensitivity analyses on each input variable of the dataset to understand its overall impact on the industrial process as well as behavior of the industrial process across the space defined by the input variables. This includes the calculation of an impact score for each input variable. In stage two, line segments are defined in the operating space of the dataset’s independent variables based on pre-defined seeds, variable's impact scores, or other parameters. Then, the sampling algorithm is applied to further learn the behavior of the industrial process on these line segments, generating surrogate functions spanning the line segments. The results of both stages are combined to generate the training dataset used to train a model of the complex industrial processes.

Embodiments of the present invention can simulate, optimize, control functions of, and/or otherwise operate a given plant using the trained model. In one non-limiting example, an embodiment of the present invention operates the given plant using the trained model including controlling the process at the given plant using the trained model. Other example embodiments operating the given plant using the trained model are within the purview of one skilled in the art given this disclosure

Embodiments include a computer-implemented method of operating a plant that comprises receiving data regarding a process at a given plant, the data comprising input variables and at least one output variable and selecting sample points in a dimensional space defined by the input variables. The method further includes, for each sample point, generating a line segment intersecting the sample point and fitting, using the received data, a function spanning the generated line segment, the fitted function deriving the at least one output variable from the input variables. The method also computes, using the fitted functions, supplemental data regarding the process at the given plant and trains a machine learning model utilizing the computed supplemental data. The method operates, using the trained machine learning model, the given plant.

The computer-implemented method may also include generating a grid in the dimensional space defined by the input variables, and wherein selecting sample points is based on the generated grid. In such embodiments, the resolution of the generated grid can be defined by a user input.

Selecting sample points in a dimensional space can be based upon impact scores of the input variables calculated using adaptive sampling. The line segment may have a slope defined by a gradient of the dimensional space at the intersected sample point. Fitting the function spanning the generated line segment can utilize adaptive learning sampling.

In some embodiments, the machine learning model is trained using a training dataset comprised of the computed supplemental data and sparse samples from the received data. In such embodiments, the computed supplemental data may be larger than that of the received data.

The machine learning model can be one of a Deep Learning or Neural Network model.

The computer-implemented method may further include defining endpoints of the line segments using model space restrictions and constraints.

The process at the given plant can be any one of an industrial process, a chemical process, a refinery process, or a manufacturing process.

Embodiments further include a system for operating a plant comprising a sampling module including at least one digital processor. The sampling module is configured to receive data regarding a process at a given plant, the data comprising input variables and at least one output variable and select sample points in a dimensional space defined by the input variables, and for each sample point. The sampling module is further configured to generate a line segment intersecting the sample point, fit, using the received data, a function spanning the generated line segment, the fitted function deriving the at least one output variable from the input variables, and compute, using the fitted functions, supplemental data regarding the process at the given plant. The system also includes a machine learning module, configured to train a machine learning model utilizing the computed supplemental data and a controller configured to operate, using the trained machine learning model, the given plant.

The sampling module can be further configured to generate a grid in the dimensional space defined by the input variables, and wherein selecting sample points is based on the generated grid. The sampling module may also be further configured to utilize adaptive sampling to calculate independent variable impact scores and select sample points based upon the calculated independent variable impact scores.

The sampling module can be further configured to use adaptive learning sampling to fit the function spanning the generated line segment. The sampling module may also be further configured to define endpoints of the line segments using model space restrictions and constraints.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram illustrating a non-limiting example network environment for adaptive sampling, model creation, and model deployment of embodiments disclosed herein.

FIG. 2 is a flow chart of a method for the creation and deployment of a model for plant process control and monitoring according to the present invention.

FIG. 3 is a graph of a one-dimensional example of the sampling algorithm utilized by embodiments of the present invention.

FIG. 4 is a flow chart of a computer-implemented method of adaptive sampling generating a training data set for machine learning according to embodiments of the present invention.

FIG. 5A is a graph that plots the behavior of a Fluid Catalytic Cracking (FCC) process in a function of output flow rate of light cracked naphtha (LCN) versus reactor temperature (RTT).

FIG. 5B is a set of graphs comparing models trained using prior art sampling methods with the actual behavior of a Fluid Catalytic Cracking (FCC) process.

FIG. 6 is a set of graphs showing surrogate functions for a Fluid Catalytic Cracking (FCC) process calculated using embodiments of the invention.

FIG. 7 is a comparison between a model constructed using prior art sampling strategies and a model constructed using sample strategies according to embodiments of the invention.

FIG. 8 is a graph showing a comparison of training efficiency of models constructed from training data gathered using prior art Sobol sequence sampling and models constructed from training data gathered using the adaptive sampling strategies according to embodiments of the invention.

FIG. 9 is a schematic view of a computer network in which embodiments can be implemented.

FIG. 10 is a block diagram of a computer node or device in the computer network of FIG. 9.

### DETAILED DESCRIPTION

A description of example embodiments follows.

Embodiments of the invention utilize a novel application of a core sampling algorithm (“sampling algorithm” or “adaptive sampling algorithm”). This sampling algorithm attempts to sample the extreme points of a function (“target function” or “truth function”) that is then learned through an iterative process of fitting a representative function (“surrogate function” or “fit function”) using the sampled points. In embodiment of the invention, the target function describes process behavior where values of input variable(s) (e.g., X or independent variables) are correlated with values of output variable(s) (e.g., Y or dependent variables). Both input and output variables can include measurements of plant behavior received from sensors, historical data, first principles, and other representations of process behavior. Often the target function is unknown and must be derived from data regarding or representations of the process behavior through a modeling process, for example by the creation of a first principles model, a hybrid model, or a data driven model created using machine learning techniques. Derived knowledge of the target function, and therefore process behavior, (for example outputs of a trained machine learning model) can be used to control or predict the plant performing the process.

The sampling algorithm can be applied to a dataset comprising values (measured, simulated, calculated, or predicted) of variables reflecting the behavior of a plant process. The goal of the sampling algorithm is to use samples (portions or working amounts) of the dataset to derive a surrogate function that reflects the true function that defines the correlation between the variables in the dataset Starting with a few samples taken from the dataset, the algorithm fits the surrogate function to the target function, takes additional samples from the dataset at the extreme points on the surrogate function, and re-fits and evaluates the surrogate function until the valuated surrogate function doesn’t change with additional samples, i.e. can be considered converged.

This sampling algorithm provides great benefits to efficiency in the creation of training datasets that can be used to train models of plant process behavior that seek to identify and replicate the variable relationships of the target function which can then be used to predict and control process behavior. Embodiments of the present invention can simulate, optimize, control functions of, and otherwise operate a given plant using the trained machine learning model. In one non-limiting example, an embodiment of the present invention operates the given plant using the trained machine learning model including controlling the process at the given plant using the trained machine learning model. Other example embodiments operating the given plant using the trained machine learning model are within the purview of one skilled in the art given this disclosure. As discussed further below, the surrogate function can be fitted to and provide information regarding a target function using relatively few samples of a dataset comprised of data for a plant process that behaves according to said target function. Nevertheless, due to the convergence of the iterative process, the surrogate function converges to the target function in its entire range. Therefore, if a machine learning model is to be built to learn the target function and the process behavior defined by said target function, every point on the surrogate function can be used as training data. The outputs of the utilized sampling algorithm referred to herein include every point on the surrogate function in addition to samples obtained from a dataset of plant process data with variable correlation defined by the target function.

### Example Network Environment for Plant Processes

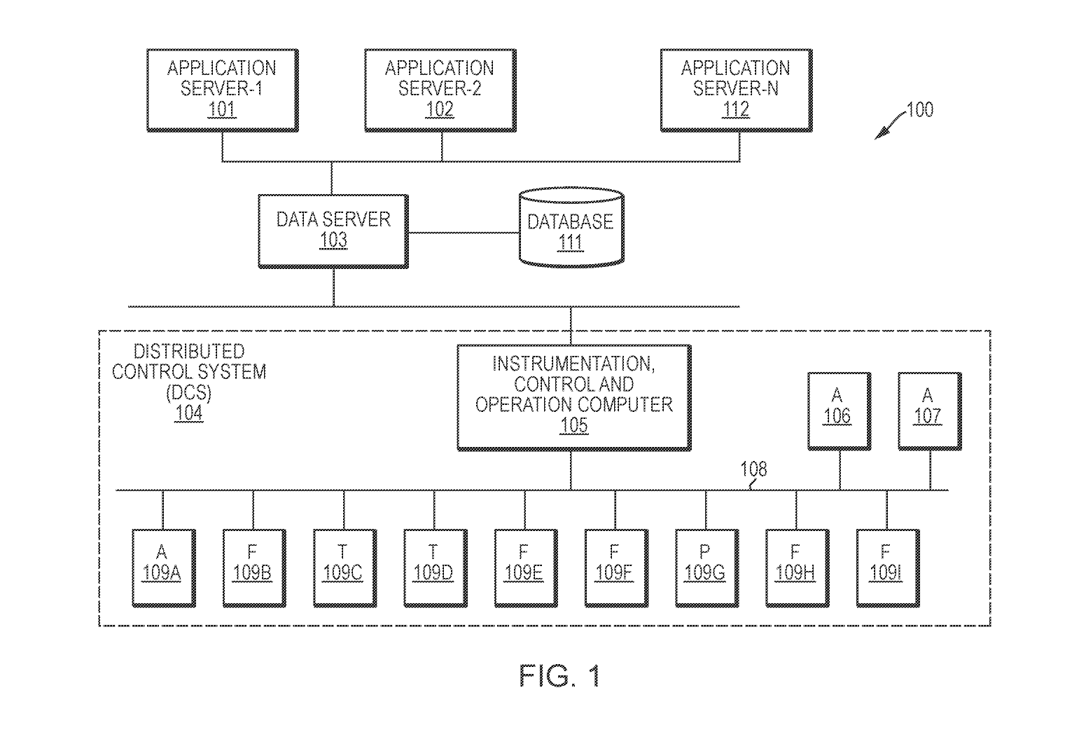

FIG. 1 illustrates a block diagram depicting an example network environment 100 for monitoring, controlling, and/or modeling plant processes in many embodiments. System computers 101, 102 may operate as controllers and utilize models trained on datasets created using the sampling strategies and sampling algorithms disclosed herein. In some embodiments, each one of the system computers 101, 102 may operate in real-time as a controller alone, or the computers 101, 102 may operate together as distributed processors contributing to real-time operations as a single controller. In other embodiments, additional system computers 112 may also operate as distributed processors contributing to the real-time operation as a controller. System computers 101, 102 and/or additional system computers 112 may be used to perform sampling strategies and algorithms disclosed herein as well as train models using the training datasets created by those sampling strategies and algorithms for deployment in network environment 100, including but not limited to use by system computers 101, 102 operating as controllers.

The system computers 101 and 102 may communicate with the data server 103 to access collected data for measurable process variables from a historian database 111. The data server 103 may be further communicatively coupled to a distributed control system (DCS) 104, or any other plant control system, which may be configured with instruments 109A-109I, 106, 107 that collect data at a regular sampling period (e.g., one sample per minute) for the measurable process variables. Instruments 106, 107 are online analyzers (e.g., gas chromatographs) that collect data at a longer sampling period. The instruments 109A – 109I, 106, 107 may communicate the collected data to an instrumentation computer 105, also configured in the DCS 104, and the instrumentation computer 105 may in turn communicate the collected data to the data server 103 over communications network 108. The data server 103 may then archive the collected data in the historian database 111 for model calibration and inferential model training purposes. The data collected varies according to the type of target process. Data server 103, historical database 111, and instruments 109A – 109I, 106, 107 may be used as sources for the dataset sampled using the sampling strategies and algorithms disclosed herein.

The collected data may include measurements for various measurable process variables. These measurements may be categorized as independent or dependent variables of the target function describing behavior of the plant processes. These measurements may include, for example, a feed stream flow rate as measured by a flow meter 109B, a feed stream temperature as measured by a temperature sensor 109C, component feed concentrations as determined by an analyzer 109A, and reflux stream temperature in a pipe as measured by a temperature sensor 109D. The collected data may also include measurements for process output stream variables, such as, for example, the concentration of produced materials, as measured by analyzers 106 and 107. The collected data may further include measurements for manipulated input variables, such as, for example, reflux flow rate as set by valve 109F and determined by flow meter 109H, a re-boiler steam flow rate as set by valve 109E and measured by flow meter 109I, and pressure in a column as controlled by a valve 109G. The collected data reflect the operation conditions of the representative plant during a particular sampling period and can be used as points on a target function describing plant behavior in the disclosed sampling algorithms and methods. The collected data is archived in the historian database 111 for model calibration and inferential model training purposes. The data collected and stored varies in form according to the type of target process.

The system computers 101 or 102 may execute various types of process controllers for online deployment purposes utilizing deployed models trained with datasets generated by the disclosed adaptive sampling strategies. The output values generated by the controller(s) on the system computers 101 or 102 may be provided to the instrumentation computer 105 over the network 108 for an operator to view or may be provided to automatically program any other component of the DCS 104, or any other plant control system or processing system coupled to the DCS system 104. Alternatively, the instrumentation computer 105 can store the historical data 111 through the data server 103 in the historian database 111 and execute the process controller(s) in a stand-alone mode. Collectively, the instrumentation computer 105, the data server 103, and various sensors and output drivers (e.g., 109A-109I, 106, 107) form the DCS 104 and can work together to implement and run the presented application.

The example architecture 100 of the computer system supports the process operation of a representative plant. In this embodiment, the representative plant may be, for example, a refinery or a chemical processing plant having a number of measurable process variables, such as, for example, temperature, pressure, and flow rate variables. It should be understood that in other embodiments a wide variety of other types of technological processes or factory equipment in the useful arts may be represented and addressed (e.g., controlled or otherwise monitored).

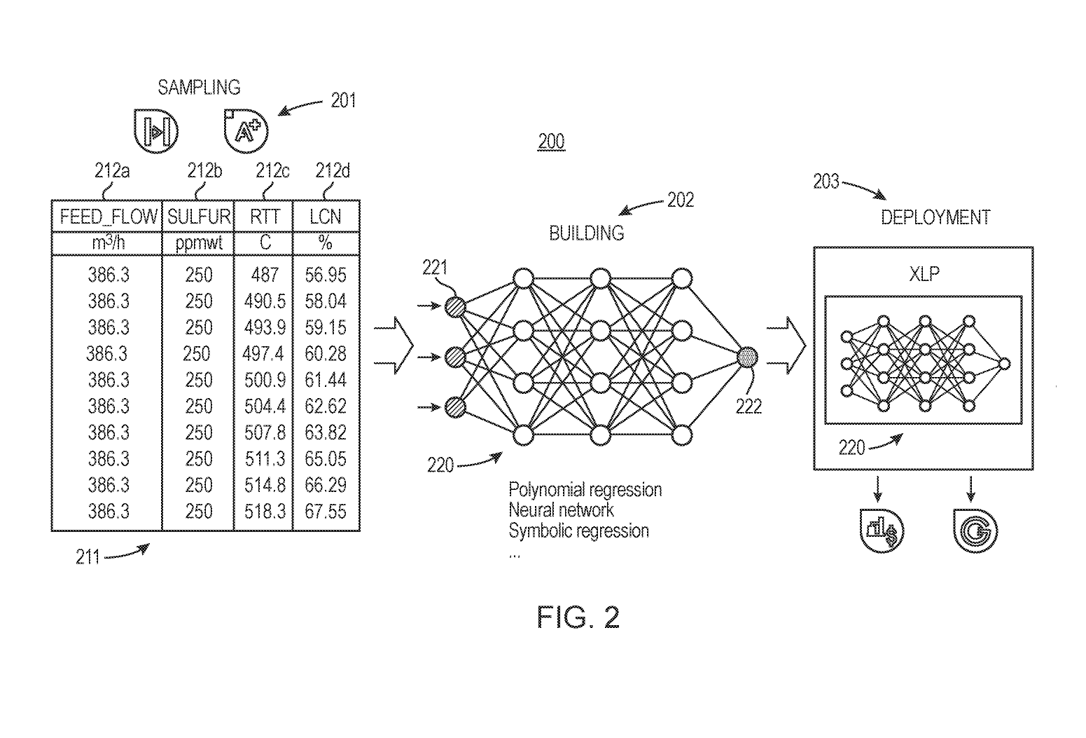

FIG. 2 is a flow chart of a method 200 of creating and using a model 220 of a plant process of interest. Method 200 is used to create a model 220 that can be used by system architecture 100 for plant process control. The created model 220 is a representation of a function defining plant or process activity and the relationships between measured plant or process variables. After deployment the created model 220 can be used to predict and control plant or process behavior. First, data sampling 201 occurs where a dataset 211 comprised of a set of variables 212a, 212b, 212c, and 212d and their values is created. Variables 212a-d may be independent or dependent variables and their values may be, or be derived from, measured plant data, historical plant data, simulated plant data, or the like. Dataset 211 may be formed of time-series wherein measurements of variables 212a-d are provided during a set time period. In prior art methods, data sampling 201 may be done by merely collecting raw plant data and measurements (e.g., from data server 103, database 111 or instruments 109A-109I, 106, 107) or generating a random sampling thereof. In embodiments of the present invention, an improved adaptive sampling strategy is used that incorporates knowledge of plant behavior.

After data is sampled at data sampling step 201, model building step 202 builds a model 220 using that sampled data. The model defines relationship(s) between independent variables 221 and dependent variable(s) 222, drawn from variables 212a-d of dataset 211. The model 220 can be built using a variety of techniques such as polynomial regression, neural networks, symbolic regression or the like. Subsequently, after the model 220 is built, deployment step 203 deploys model 220, for non-limited example in system architecture 100 and on servers 101, 102 to perform process control. The deployed model 220, can be used to determine and predict the behavior of dependent variable(s) 222 based on the values of independent variables 221. This knowledge can be used to control the modeled process (plant process of interest). Embodiments of the present invention can use deployed model 220 to perform any one or combination of: simulate, optimize, control functions of, and otherwise operate a given plant using the trained machine learning model. In one non-limiting example, an embodiment of the present invention uses deployed model 220 to operate the given plant using the trained machine learning model including controlling the process at the given plant using the trained machine learning model. Other example embodiments operating the given plant using the deployed model 220 are within the purview of one skilled in the art given this disclosure. Improving any of the steps of sampling 201, building 202, and deployment 203, and increasing knowledge regarding the modeled process, improves plant operations and control.

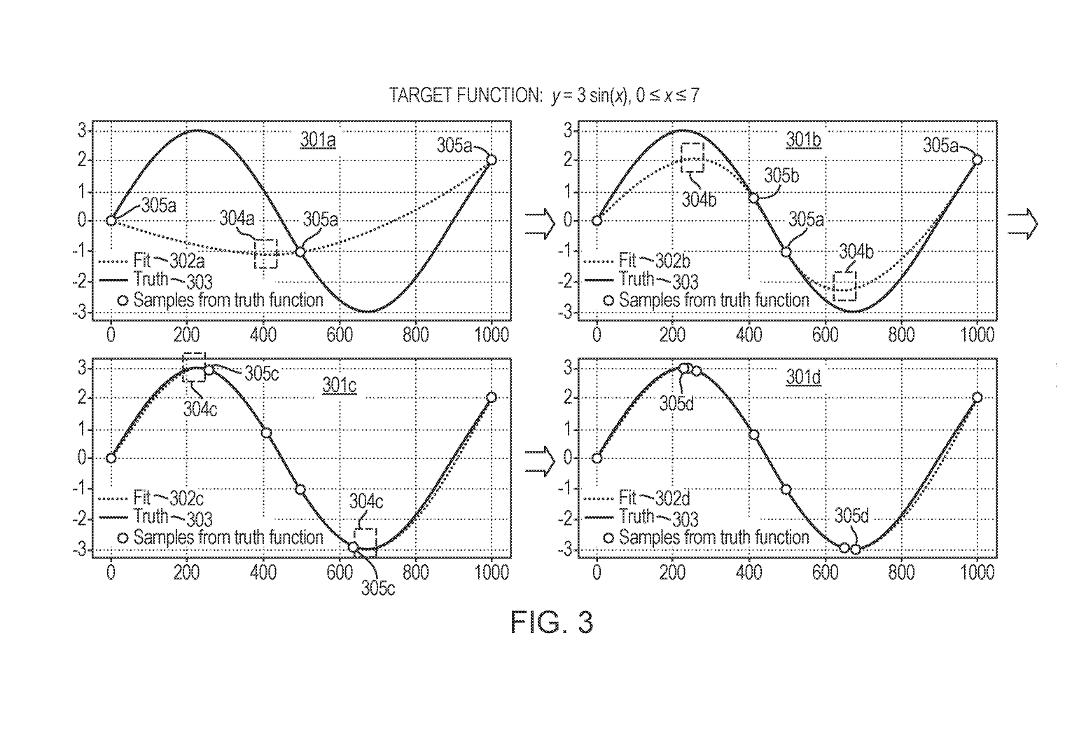

FIG. 3 is a one-dimensional example of the sampling algorithm (method) utilized by embodiments of the present invention. The sampling algorithm is performed on a dataset comprising variables (in this example X and Y) and values thereof. The variables are correlated with each other as defined by a target function, in the illustrated example y=3sin(x). The sampling algorithm and application thereof is configured to “learn” the target function by fitting a surrogate function to a “fit” or surrogate function 302a, 302b, 302c, 302d to the “truth” or target function 303 using select datapoints 305a, 305b, 305c, 305d. Datapoints 305a, 305b, 305c, 305d are selected from the dataset and, due to the inherent correlation of the variables in the dataset, are located on target function 303. The set of iterative graphs 301a, 301b, 301c, 301d show the progressive fitting of “fit” or surrogate function 302a, 302b, 302c, 302d to the “truth” or target function 303 of y=3sin(x). First, a set of points 305a on truth function 303 are selected and used to generate fit function 302a (shown in graph 301a) that also includes those points 305a. Naturally because only a few points 305a are used initially, the truth function 303 and fit function 302a diverge significantly. After the initial generation of fit function 302a, at least one location 304a on fit function 302a is chosen and new points 305b on truth function 303 are selected in that area and a new fit function 302b is generated using the original points 305a and new points 305b (shown in graph 301b). This process is repeated for points 305c drawn from areas 304b and points 305 d drawn from areas 304c resulting in fit functions 302c (shown in graph 301c) and 302d (shown in graph 301d). Locations 304a, 305b, 304c, 305d may be the extremes of (or other important positions on) surrogate functions 302a, 302b, 302c, 302d. In the shown example, only 9 samples 305a, 305b, 305c, and 305d were needed to converge fit function 302d to truth function 303, without knowledge of the target function 303. Final surrogate function 302d provides representative information of the entirety of target function 303 despite being generated using only a few select points 305a, 305b, 305c, and 305d. After convergence, fit function 302d can be used to represent truth function 303 and generate additional datapoints consistent with truth function 303 even with limited knowledge of the actual target function and/or its component datapoints.

The sampling algorithm (method) demonstrated in FIG. 3 can be used for both steps of the disclosed sampling strategy applied to a dataset of measurable plant process variables. First, the sampling algorithm (method) can be used to conduct a sensitivity analysis for each independent variable, for example by generating a surrogate function to derive and quantify an independent variable’s relationship with select dependent variables. Properties of the surrogate function and/or points on the surrogate function can then be used to calculate an impact score. Results at the end of the first step or stage of Applicant's sampling strategy include impact scores for each input (independent) variable. Second, the sampling algorithm (method) can be used to generate a surrogate function defining a relationship between select independent variables and dependent variables on line segments in the independent variable space intersecting select points on the target function. The density of the selected points can be determined by multiple factors, including user input, model predictions, and variable impact scores. The density of the selected points may be increased in areas of the variable space where the target function is expected to be highly variable (e.g., an over-cracking peak) to better capture process behavior. Points on surrogate functions spanning the line segments can be used to construct training datasets that train models of the target function, without concrete knowledge of the actual target function. Furthermore, the surrogate functions provide the additional ability to fill in gaps where the actual data may be missing or limited (sparse data). For example, if actual plant data is missing for particular variable values, the values provided by the surrogate functions can be used as “virtual” data points. This improves the resulting training dataset and therefore improves the models created.

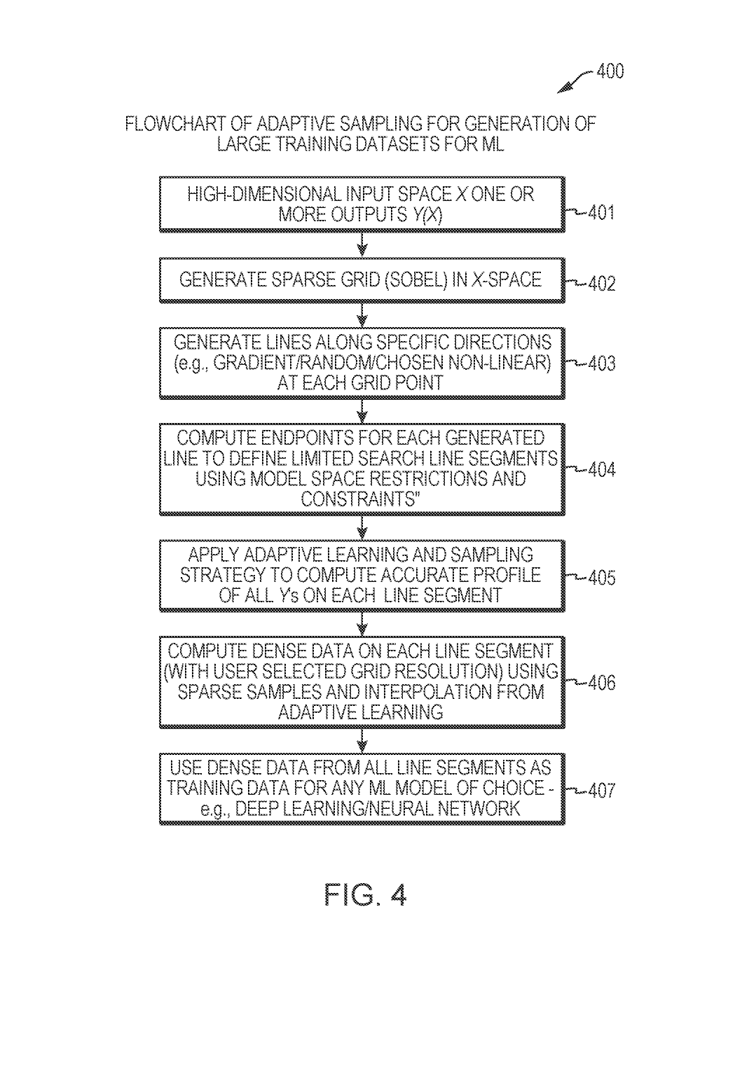

FIG. 4 is a flow chart of a computer-implemented (or otherwise computer-automated) method 400 for adaptive sampling used to generate a training data set for machine learning models according to embodiments of the invention. Method 400, through application of adaptive sampling and the sampling algorithm (method) disclosed herein, enables the creation of a large training dataset from a dataset of measurable plant process variables and their values. This large training dataset is created using fewer actual points/samples from the dataset of measurable plant process variables than prior art methods. The created training dataset can subsequently be used to create and train machine learning, or other models, intended to reflect plant process behavior. These resulting models accurately reflect plant process behavior and the correlation(s) between plant process variables enabling them to be used to predict and control said plant process.

There is a true or target function that defines the relationship between plant process variables which machine learning models can be trained to learn and replicate using training datasets. These training datasets are comprised of datapoints that provide the values, measurements, or calculations of plant process variables. The more comprehensive and accurate the training datasets, the better (more accurate or precise) the resulting model. In contrast to prior art methods, Applicant’s adaptive sampling utilizes learned information about the target function of plant behavior, provided by derived surrogate functions, to enable the creation of accurate and comprehensive training datasets. This can be accomplished even if the number of actual samples (values) of plant process variables are limited. Adaptive sampling techniques and the sampling algorithm as utilized in method 400, can calculate multiple surrogate functions fitted to a subject target function and therefore share the same relationship between plant process variables and subsequently use points located on the surrogate functions as data in training datasets. For non-limiting example, even if the actual collected data of plant process variables is limited to set intervals (e.g., 5, 10, 15, …) the surrogate functions can provide data between said intervals (e.g., 1-4, 6-9, 11-14 …) that retains the same variable correlation as the collected data of plant process variables

Method 400 begins with processor receipt of, access of, or otherwise obtaining 401 plant/process data with a relatively high dimensional input space (X) and one or more outputs or dependent variables Y(X). The received set of data may be taken from data server 103 and historical database 111 and comprise historical plant measurements, current plant measurements, simulated plant measurements or other representations of measurable plant variables. The received set of data may be derived from a simulation or first principal model of a plant process or a combination of both simulated and measured data.

Next, the processor/method step 402 generates a sparse grid comprised of select datapoints from the received set of data. The processor generates the sparse grid in the X-space (independent variable space) of the received data. The distribution of the datapoints helps ensure that representative locations of the independent variable space are included in the subsequent method steps. The generation of the grid may be done using a Sobol sequence or other known methods of distributed sampling. In some cases, method step 402 uses the variable impact score (calculated above in the disclosed sampling algorithm of FIG. 3) to select points on the grid and to determine the grid density and/or sampling frequency.

For each selected grid datapoint, the processor/method step 403 generates lines along a specific direction. The lines may be based on the gradient, random, specified by a user, or determined in another manner. The lines are generated in the space defined by the input variables of the received set of data and are independent of the dependent variables and their measurements. In turn, the processor/method step 404 computes endpoints for each generated line of step 403 and therewith defines a line segment with a limited search space. Endpoints can be determined using model space restrictions and constraints. Each line segment defines a concrete range of independent variable(s) that can be used as the boundaries for the sampling algorithm.

After defining the line segments, the processor/method step 405 applies an adaptive learning and sampling strategy. The adaptive learning and sampling strategy seeks to iteratively fit a surrogate function to a target function defining variable relationships (i.e., relationships between and among variables) using selected datapoints until the two functions converge. Datapoints in the received set of data located on the line segments are selected and used to iteratively fit a surrogate function, spanning each line segment, until the surrogate function converges and does not materially change with the addition of new datapoints. After convergence, the surrogate function can be used as a representative of the target or true function (that defines the actual relationship between sampled plant process variables). The surrogate function, derived using adaptive learning and the sampling algorithm disclosed herein, enables the calculation of values of the dependent variable(s) Y from independent variable(s) X across all line segments. Due to its iterative and adaptive nature, the sampling algorithm only requires a limited number of datapoints to reach convergence while still providing variable correlation information across its entire range.

Next, using the resulting surrogate functions, the processor/method step 406 computes dense data. The dense data can be comprised of both original datapoints located on the target function (e.g., data received in step 401, such as but not limited to plant measurements, simulated datapoints, and historical plant data) as well as interpolated data from the surrogate functions. Because the surrogate functions are smooth, they can provide any number of desired datapoints within their range by merely selecting points on the functions. A user may select a grid resolution to control the distribution of the computed dense data. If datapoints at a desired location do not exist in the received plant/process data, points from derived surrogate functions can be used to fill those gaps and complete the grid. This enables the generation of a large training dataset using far fewer actual samples from simulation/experiments/plant measurements. For example, 1000s of samples of plant/process data can provide 100,000s of training data samples by being used to derive a surrogate function with the adaptive learning and sampling strategy disclosed herein by Applicants.

Finally, the computed dense data can be used 407 as training data for machine learning (ML) models, such as but not limited to, deep learning or neural network models. The processor/method step 407 feeds or otherwise outputs the computed dense data to training data memory storage and ML training modules. In this way, step 407 supports and enables training of the ML models to predict and/or control the behavior of the plant/process, for example by being utilized as part of controllers hosted on servers 102, 103 of system 100. By expanding the limited amount of plant/process data received in step 401 to the dense data utilized to train machine learning models in step 407, method 400 provides improved training datasets without the need to actually collect or generate a large amount of plant/process data. Furthermore, the training dataset can be generated by taking into account the behavior of the plant/process, for example in step 402 by varying the grid resolution based upon a variable’s impact score. For example, a high impact score may necessitate a denser grid to better reflect sensitivity to a particular variable or a particular location in the input space. Similarly, the grid resolution used in step 406 can also be variable (user-selectable and the like) based on the properties of the fitted surrogate functions and the needs of the machine learning model.

Embodiments of the disclosed invention and the sampling algorithm utilized are widely applicable to any complex multi-dimensional model for any manner of plant process or sub-assembly operation. The following is a specific example of Applicant's inventive techniques (present invention) being utilized for a Fluid Catalytic Cracking (FCC) reactor model and process, a key chemical process in the refinery industry. FCC converts the high-boiling point, high-molecular weight crude oils into gasoline, olefinic gases, and other petroleum products.

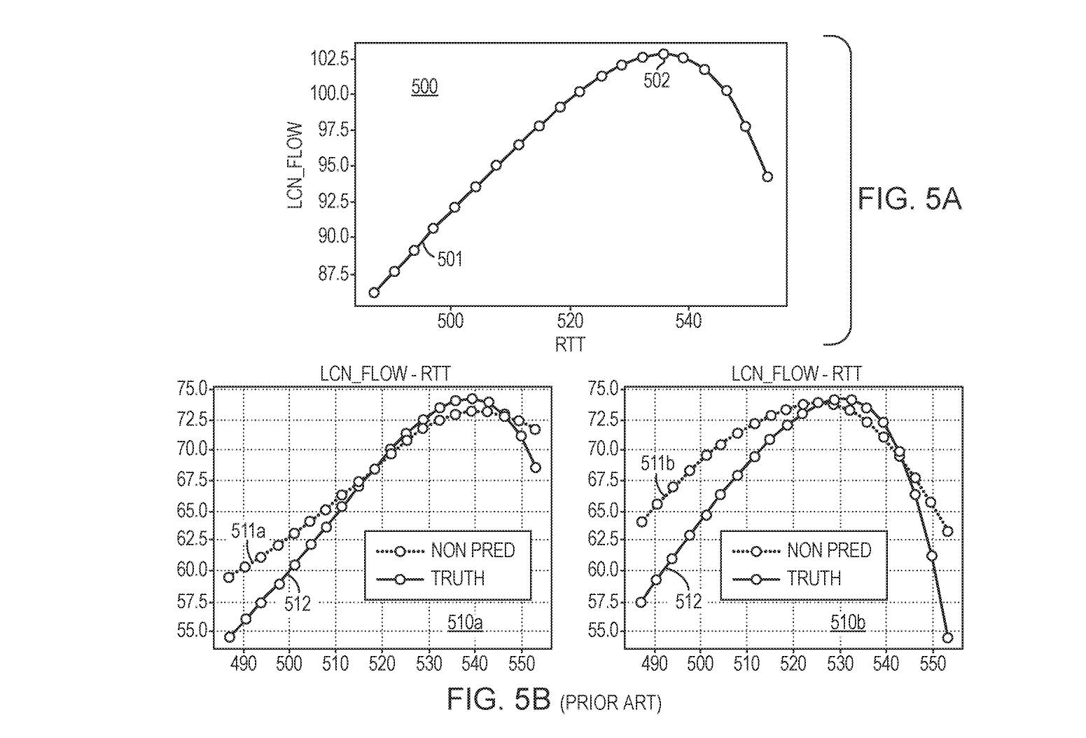

FIG. 5A is a graph 500 that plots the behavior of a Fluid Catalytic Cracking (FCC) process in a function 501 of the output flow rate of light cracked naphtha (LCN) versus reactor temperature (RTT). A key property of the FCC process is the existence of an over-cracking peak 502 at which increasing reactor temperature begins to swiftly lower output flow. A similar over-cracking peak 502 also exists for the flows of heavy cracked naphtha (HCN), and LCN-HCN swing. Ideally, reactor temperature should be controlled to approach the over-cracking peak 502 but not surpass it, maximizing output flow (main yield). Due to the sensitivity of the flow rate surrounding the over-cracking peak 502, fine control is required to maximize FCC efficiency and therefore accurate models are needed to achieve that fine control.

FIG. 5B is a set of graphs 510a510b comparing prediction 511a511b of models trained using prior art sampling methods with the actual behavior 512 of a Fluid Catalytic Cracking (FCC) process. If models are trained using training datasets created using prior art model-independent sampling methods, such as random sample, Latin hypercube, or Sobol sequence, then the models may not be accurate enough to capture the actual behavior 512 of a Fluid Catalytic Cracking (FCC) process. In particular, the over-cracking peak 502 may be modeled incorrectly. This diminishes process efficiency. For an FCC model, a key result is the over-cracking peak 502 which describes the relationship between reactor temperature and a main yield or output. When the reactor temperature is at its lower range, it has a positive correlation with the yield. However, after a certain point, the temperature becomes negatively correlated with the yield. Such relationship needs to be modeled accurately so optimization can be smoothly conducted to maximize the plant operations and profit. The prior art sampling methods do not generate models 511a, 511b that model the over-cracking peak 502 to a satisfactory level, leading to sub-optimal results and related optimization problems.

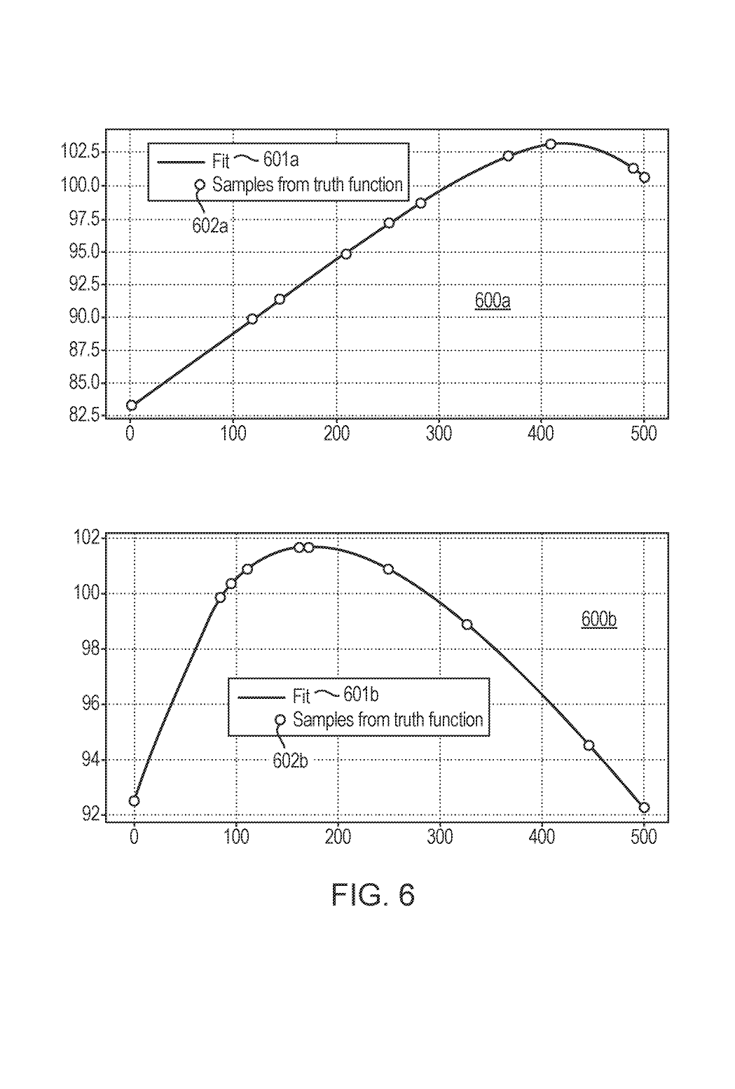

FIG. 6 is a set of graphs 600a, 600b showing surrogate functions 601a, 601b for a Fluid Catalytic Cracking (FCC) process calculated using embodiments of the invention. In contrast to prior art sampling methods, if the adaptive sampling algorithm is used to calculate surrogate functions 601a, 601b using data points 602a, 602b taken from the target function defining process behavior, a training dataset that more accurately captures the over-cracking peak can be generated which in turn results in a more accurate model. Additionally, (1) the adaptive sampling algorithm only needs to sample critical points along a line, improving sampling efficiency, and (2) the search heuristic (e.g., search along the gradient direction or based on variable impact score) can be plugged in (user selectable) to prefer sampling complex regions. Finally, although only several points 602a, 602b were sampled from the function representative of FCC process behavior, any point across the entire curve defined by surrogate functions 601a, 601b can be used to train a model due to surrogate functions’ 601a, 601b convergence with the target function of the FCC process behavior. Surrogate functions 601a, 601b can be calculated for any number of line segments intersecting select points of the target function of the FCC process in any desired direction intersecting behavior. The selection of these points may be based on inputted grid resolution, variable impact scores, model calculations or products, or other properties of and related to the FCC process to be modeled. This flexibility allows for applications of the sampling algorithm to both learn and take into account the properties of the target function defining subject process behavior of interest.

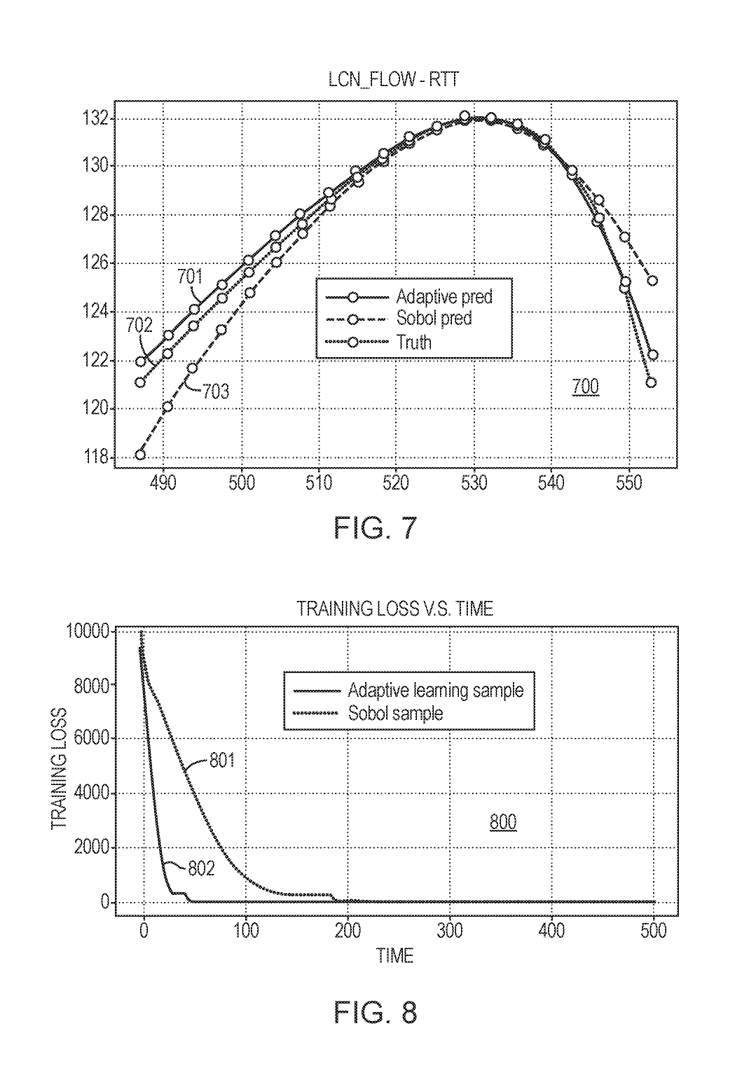

FIG. 7 is a comparison between a model 703 constructed using prior art sampling strategies and a model 701 constructed using sample strategies according to embodiments of the invention. Graph 700 displays three functions, namely: (1) a function 702 showing the true over-cracking peak of an FCC process, (2) a function 701 showing the output of a model constructed from training data gathered using the adaptive sampling strategies disclosed herein, and (3) a function 703 showing the output of a model constructed from training data gathered using prior art Sobol sequence sampling. Function 701 is a much better (more closely mimicking) representative of function 702 than function 703 demonstrating the ability of the adaptive sampling strategy to train superior models. With the disclosed invention, modeling of the over-cracking peak is significantly improved, thus enabling wider and improved applications of hybrid models.

FIG. 8 is a graph showing a comparison of training efficiency of models 801 constructed from training data gathered using prior art Sobol sequence sampling and models 802 constructed from training data gathered using the adaptive sampling strategies according to embodiments of the invention. In the case of complex hybrid models such as deep neural networks, the adaptive sampling strategy can also significantly improve the efficiency of model construction, due to a large amount of extra data (e.g., data points) generated. Curves 801, 802 on graph 800 show the loss function versus time for models 801 constructed from training data gathered using prior art Sobol sequence sampling and models 802 constructed from training data gathered using Applicant's adaptive sampling disclosed herein. The increased sharpness of curve 802 shows how much more efficiently the model construction completes when adaptive sampling of the present invention is used. Adaptive sampling was able to generate a training dataset of 112,500 datapoints in comparison to Sobol sequence sampling which only provided a training dataset of 2375 datapoints.

### Example Digital Processing Environment

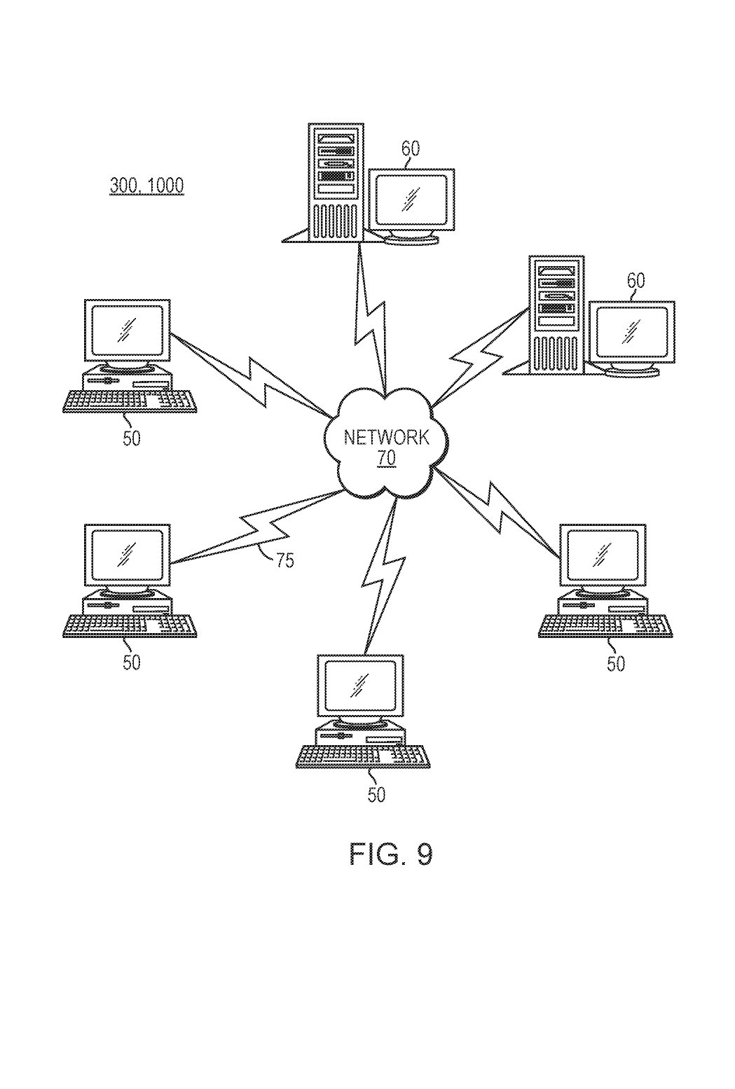

FIG. 9 illustrates a computer network or similar digital processing environment in which the disclosed embodiments 100, 200 may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

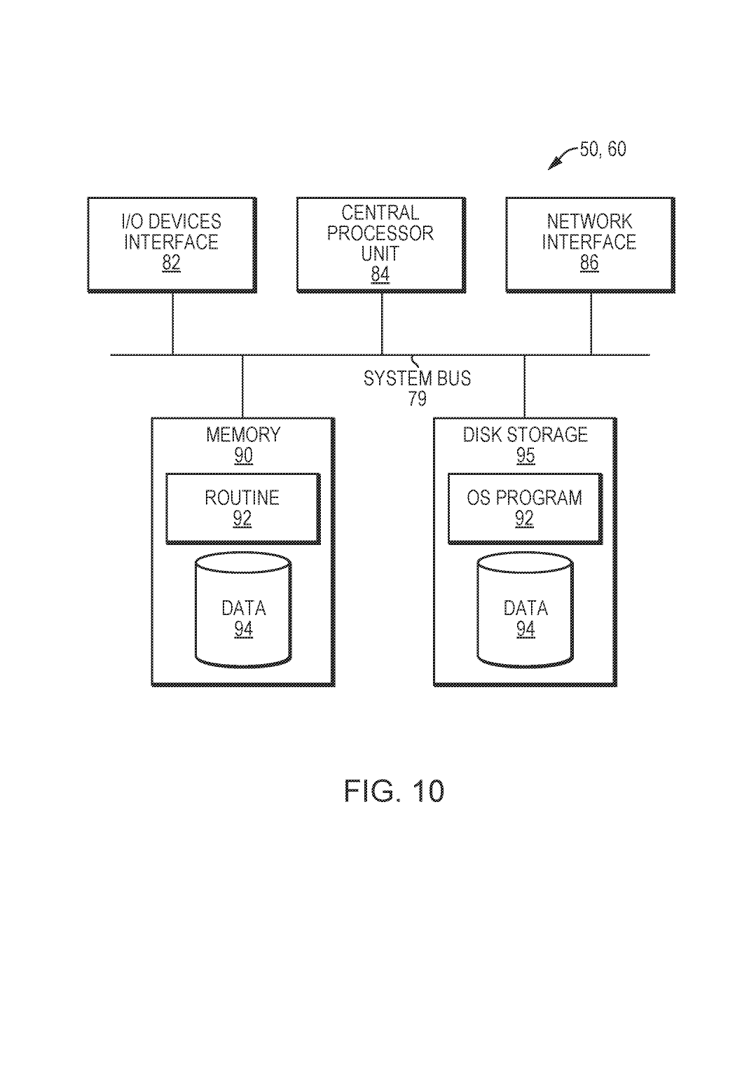

FIG. 10 is a block diagram of the internal structure of a computer (e.g., client processor/device 50 or server computers 60) in the computer system of FIG. 9. Each computer 50, 60 contains system bus 79, where a bus is a set of hardware lines used for data transfer among the components of a computer or digital processing system. Bus 79 is essentially a shared conduit that connects different elements of a computer system (e.g., processor, disk storage, memory, input/output ports, network ports) that enables the transfer of information between the elements. Attached to system bus 79 is I/O device interface 82 for connecting various input and output devices (e.g., keyboard, mouse, displays, printers, speakers) to the computer 50, 60. Network interface 86 allows the computer to connect to various other devices attached to a network (e.g., network 70 of FIG. 9). Memory 90 provides volatile storage for computer software instructions 92 and data 94 used to implement an embodiment (e.g., steps 201, 202, 203 of FIG. 2, the adaptive sampling strategy shown in FIG. 3, and workflow 400 of FIG. 4). Disk storage 95 provides non-volatile storage for computer software instructions 92 and data 94 used to implement an embodiment. Data 94 may include measurable plant data, machine learning models, tools for training machine learning models, sampling algorithms as previously discussed. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM’s, CD-ROM’s, diskettes, tapes) that provides at least a portion of the software instructions for the disclosed system. Computer program product 92 can be installed by any suitable software installation procedure, as is well known in the art. In another embodiment, at least a portion of the software instructions may also be downloaded over a cable, communication, and/or wireless connection. In other embodiments, the programs are a computer program propagated signal product 75 (FIG. 9) embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like. In other embodiments, the program product 92 may be implemented as a so-called Software as a Service (SaaS), or other installation or communication supporting end-users.

It should be understood that the flow diagrams, block diagrams, and network diagrams may include more or fewer elements, be arranged differently, or be represented differently. But further it should be understood that certain implementations may dictate the block and network diagrams and the number of block and network diagrams illustrating the execution of the embodiments be implemented in a particular way. Accordingly, further embodiments may also be implemented in a variety of computer architectures, physical, virtual, cloud computers, and/or some combination thereof, and, thus, the data processors described herein are intended for purposes of illustration only and not as limitations of the embodiments.

While example embodiments have been particularly shown and described, it will be understood by those skilled in the art that various changes in form and details may be made therein without departing from the scope of the embodiments encompassed by the appended claims.

What is claimed is:

1. A computer-implemented method of operating a plant comprising:
receiving data regarding a process at a given plant, the data comprising input variables and at least one output variable;
selecting sample points in a dimensional space defined by the input variables, and for each sample point:
generating a line segment intersecting the sample point;
fitting, using the received data, a function spanning the generated line segment, the fitted function deriving the at least one output variable from the input variables;
computing, using the fitted functions, supplemental data regarding the process at the given plant;
training a machine learning model utilizing the computed supplemental data; and
operating, using the trained machine learning model, the given plant.

2. The computer-implemented method of operating a plant of claim 1 further comprising generating a grid in the dimensional space defined by the input variables, and wherein selecting sample points is based on the generated grid.

3. The computer-implemented method of operating a plant of claim 2 wherein resolution of the generated grid is defined by a user input.

4. The computer-implemented method of operating a plant of claim 1 wherein selecting sample points in a dimensional space is based upon impact scores of the input variables calculated using adaptive sampling.

5. The computer-implemented method of operating a plant of claim 1 wherein the line segment has a slope defined by a gradient of the dimensional space at the intersected sample point.

6. The computer-implemented method of operating a plant of claim 1 wherein fitting the function spanning the generated line segment utilizes adaptive learning sampling.

7. The computer-implemented method of operating a plant of claim 1 wherein the machine learning model is trained using a training dataset comprised of the computed supplemental data and sparse samples from the received data.

8. The computer-implemented method of operating a plant of claim 7 wherein an amount of the computed supplemental data is larger than that of the received data.

9. The computer-implemented method of operating a plant of claim 1 wherein the machine learning model is one of a Deep Learning or Neural Network model.

10. The computer-implemented method of operating a plant of claim 1 further comprising defining endpoints of the line segments using model space restrictions and constraints.

11. The computer-implemented method of operating a plant of claim 1 wherein the process at the given plant is any one of an industrial process, a chemical process, a refinery process, or a manufacturing process.

12. A system for operating a plant, the system comprising:
a sampling module including at least one digital processor, the sampling module configured to:
receive data regarding a process at a given plant, the data comprising input variables and at least one output variable;
select sample points in a dimensional space defined by the input variables, and for each sample point;
generate a line segment intersecting the sample point;
fit, using the received data, a function spanning the generated line segment, the fitted function deriving the at least one output variable from the input variables; and
compute, using the fitted functions, supplemental data regarding the process at the given plant;
a machine learning module, configured to train a machine learning model utilizing the computed supplemental data; and
a controller configured to operate, using the trained machine learning model, the given plant.

13. The system for operating a plant of claim 12 wherein the sampling module is further configured to generate a grid in the dimensional space defined by the input variables, and wherein selecting sample points is based on the generated grid.

14. The system for operating a plant of claim 12 wherein the sampling module is further configured to utilize adaptive sampling to calculate independent variable impact scores and select sample points based upon the calculated independent variable impact scores.

15. The system for operating a plant of claim 12 wherein the line segment has a slope defined by a gradient of the dimensional space at the intersected sample point.

16. The system for operating a plant of claim 12 wherein the sampling module is further configured to use adaptive learning sampling to fit the function spanning the generated line segment.

17. The system for operating a plant of claim 1 wherein the machine learning model is one of a Deep Learning or Neural Network model.

18. The system for operating a plant of claim 1 wherein the sampling module is further configured to define endpoints of the line segments using model space restrictions and constraints.

19. A non-transitory computer-readable data storage medium comprising instructions to cause a computer to:
receive data regarding a process at a given plant, the data comprising input variables and at least one output variable;
select sample points in a dimensional space defined by the input variables, and for each sample point:
generate a line segment intersecting the sample point; and
fit, using the received data, a function spanning the generated line segment, the fitted function deriving the at least one output variable from the input variables;
compute, using the fitted functions, supplemental data regarding the process at the given plant; and
generate a training dataset for a machine learning model comprising the supplemental data, the machine learning model configured to operate the given plant.

20. The non-transitory computer-readable data storage medium of claim 19 wherein the instructions further cause the computer to utilize adaptive sampling to calculate independent variable impact scores and select the sample points based on the calculated independent variable impact scores.
